(19) United States
(12) Patent Application Publication
(10) Pub. No.: US 2018/0259789 A1
(43) Pub. Date: Sep. 13, 2018

(54) Eyeglass Attachment System

(71) Applicant: Christopher Lee Bruender, Amston, CT (US)

(72) Inventor: Christopher Lee Bruender, Amston, CT (US)

(21) Appl. No.: 15/917,316

(22) Filed: Mar. 9, 2018

Related U.S. Application Data
(60) Provisional application No. 62/469,369, filed on Mar. 9, 2017.

(51) Int. Cl. G02C 3/04; G02C 9/02

(52) U.S. Cl. CPC G02C 3/04; G02C 2200/02; G02C 9/02

(57) ABSTRACT

An eyeglass attachment system, for use with a pair of eyeglasses having a frame having a main portion and a pair of temple pieces hingedly attached to the main portion. A pair of mountable units each have a housing and a securing strap. Each housing has a bottom having a clamping mechanism and a securing strap that extends from the housing. The mountable unit is attached onto one of the temple pieces by extending the securing strap around one of the temple pieces and then securing it in place with the clamping mechanism. A magnet is provided in the housing so that the eyeglasses can be gripped onto an article of clothing and held thereto by the magnetic attraction of the mountable units toward each other.

### TECHNICAL FIELD

The present disclosure relates generally to an eyeglass attachment system. More particularly, the present disclosure relates to a device that facilitates attachment of eyeglasses on a garment of a user so that they are conveniently available when needed.

### BACKGROUND

A significant segment of the population must wear eyeglasses or use other corrective lenses due to myopia or hyperopia. Such eyeglasses or lenses are typically worn throughout the waking hours of the day.

An even larger segment of the population, however, will require reading glasses on an intermittent basis as they age. Since reading glasses are only helpful while reading and actually interfere with distance vision at other times, people continually and repeatedly put on and take off these glasses.

The problem with frequently taking off glasses, is that they might not be conveniently available next time they are needed. Also, when placed down on a surface they can be easily misplaced or broken. As a result, people have tried various schemes for holding eyeglasses and keeping them available, including wearing them on a neck chain, placing them in a pocket, or holding them on a shirt collar. Often this provides a false sense of security, and will lead to the glasses being broken or lost. Other devices have been proposed that magnetically clip onto a garment but are only attachable onto eyeglasses having certain configurations, shapes, and sizes.

While these units may be suitable for the particular purpose employed, or for general use, they would not be as suitable for the purposes of the present disclosure as disclosed hereafter.

In the present disclosure, where a document, act or item of knowledge is referred to or discussed, this reference or discussion is not an admission that the document, act or item of knowledge or any combination thereof was at the priority date, publicly available, known to the public, part of common general knowledge or otherwise constitutes prior art under the applicable statutory provisions; or is known to be relevant to an attempt to solve any problem with which the present disclosure is concerned.

While certain aspects of conventional technologies have been discussed to facilitate the present disclosure, no technical aspects are disclaimed and it is contemplated that the claims may encompass one or more of the conventional technical aspects discussed herein.

### BRIEF SUMMARY

An aspect of an example embodiment in the present disclosure is to provide an eyeglass attachment system that securely holds a pair of eyeglasses, keeping them conveniently available to a user. Accordingly, the present disclosure provides an eyeglass attachment system that magnetically holds the temple pieces of a pair of eyeglasses securely together. A portion of a garment or similar item of the user may be interposed between the temple pieces so that the eyeglasses are held securely thereto.

It is another aspect of an example embodiment in the present disclosure to provide an eyeglass attachment system that can be employed with a large variety of existing eyeglasses. Accordingly, the eyeglass attachment system is configured to mount to the temple pieces of existing eyeglasses. Each mountable unit has a securing strap that extends around one of the temple pieces. The securing straps can be adjusted to any length needed to extend around the temple pieces.

Accordingly, the present disclosure describes an eyeglass attachment system, for use with a pair of eyeglasses having a frame having a main portion and a pair of temple pieces hingedly attached to the main portion. A pair of mountable units each have a housing and a securing strap. Each housing has a bottom having a clamping mechanism and a securing strap that extends from the housing. The mountable unit is attached onto one of the temple pieces by extending the securing strap around one of the temple pieces and then securing it in place with the clamping mechanism. A magnet is provided in the housing so that the eyeglasses can be gripped onto an article of clothing and held thereto by magnetic attraction of the mountable units toward each other.

The present disclosure addresses at least one of the foregoing disadvantages. However, it is contemplated that the present disclosure may prove useful in addressing other problems and deficiencies in a number of technical areas. Therefore, the claims should not necessarily be construed as limited to addressing any of the particular problems or deficiencies discussed hereinabove. To the accomplishment of the above, this disclosure may be embodied in the form illustrated in the accompanying drawings. Attention is called to the fact, however, that the drawings are illustrative only. Variations are contemplated as being part of the disclosure.

### BRIEF DESCRIPTION OF THE DRAWINGS

In the drawings, like elements are depicted by like reference numerals. The drawings are briefly described as follows.

FIG. 1 is diagrammatic perspective view, illustrating an example embodiment of the eyeglass attachment system with a pair of mountable units installed on a pair of eyeglasses.

FIG. 2 is a bottom plan view, illustrating the mountable units joined together, thereby holding the temple pieces of the eyeglasses together.

FIG. 3 is a diagrammatic perspective view, illustrating one of the mountable units, upside down.

FIG. 4 is a diagrammatic perspective view, illustrating one of the mountable units, wherein the free end of the securing strap is secured by an embodiment of the clamping mechanism.

FIG. 5 is an alternate diagrammatic perspective view, illustrating the rear plate, and illustrating a decorative panel being attached thereto.

FIG. 6 is a diagrammatic perspective view, showing an embodiment of the mountable unit with the strap removed and with a further embodiment of the clamping mechanism.

The present disclosure now will be described more fully hereinafter with reference to the accompanying drawings, which show various example embodiments. However, the present disclosure may be embodied in many different forms and should not be construed as limited to the example embodiments set forth herein. Rather, these example embodiments are provided so that the present disclosure is thorough, complete and fully conveys the scope of the present disclosure to those skilled in the art.

### DETAILED DESCRIPTION OF THE PREFERRED EMBODIMENTS

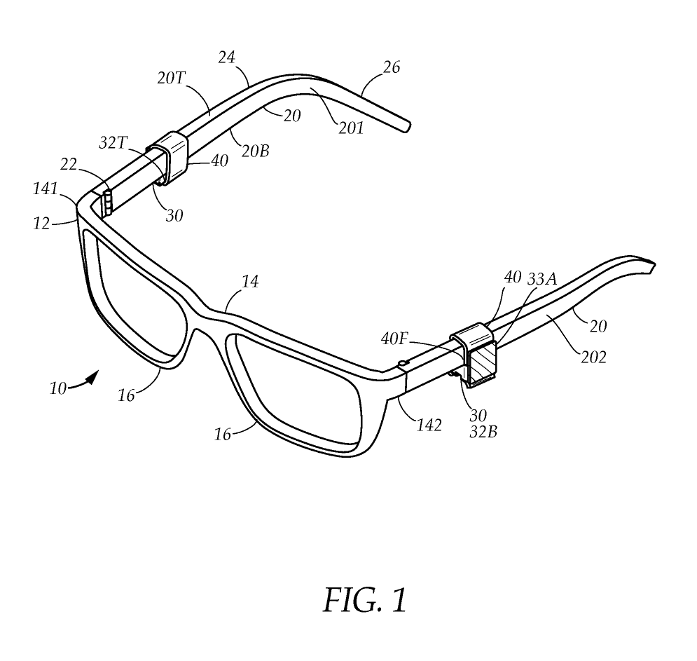

FIG. 1 illustrates a pair of eyeglasses 10, having a frame 12 with a main portion 14 having a first end 141 and a second end 142. The main portion 14 has a pair of lens openings 16 for holding a pair of lenses 18 within said lens openings 16. The frame 12 also includes a pair of temple pieces 20, each temple piece attached to the main portion 14 with a hinge 22. One of the temple pieces 20 is attached at the first end 141 of the main portion and the other of the temple pieces 20 is attached at the second end 142 of the main portion 14. Each of the temple pieces 20 have a shank 24 that is attached to one of the hinges 22 and an ear part 26 that is located on the shank on an end opposite from said hinge 22. Each temple piece 20 has an inside surface 201, an outside surface 202, a top 20T, and a bottom 20B.

As illustrated in FIG. 1, an eyeglass attachment system is secured onto the eyeglasses in an extended position where the temple pieces 20 extend nearly perpendicular to the main portion 14. The eyeglass attachment system includes a pair of mountable units 30 that are each secured to one of the temple pieces 20. In particular, each mountable unit 30 is attached onto one of the temple pieces 20 on its shank 24 between the hinge 22 and ear part 26.

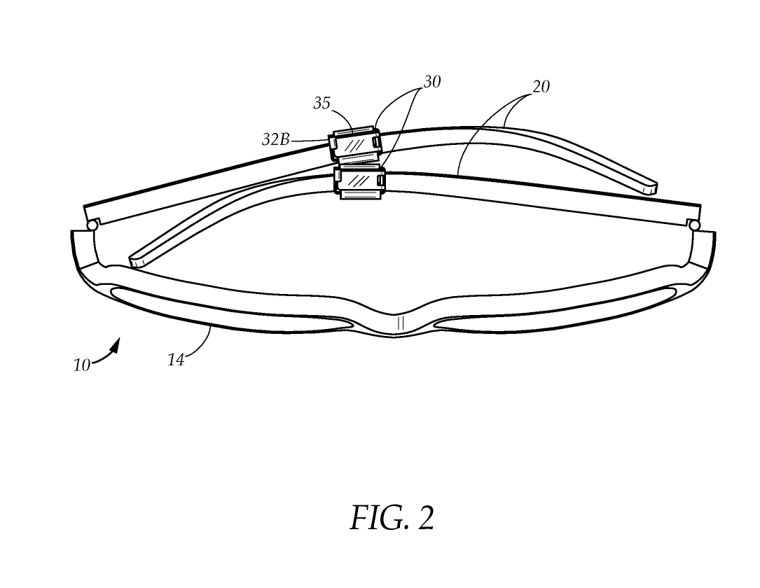

Referring to FIG. 2, the eyeglasses 10 are in a folded position, whereby the temple pieces 20 overlap alongside each other and the main portion 14. Note that the mountable units 30 are suitably positioned so that when the eyeglasses are in the folded position, the mountable units 30 are brought into close proximity with each other, and join securely together magnetically, as will be described in further detail hereinafter. With the magnetic joinder of the mountable units 30, any garment portion or other thin item of the user that is placed between the mountable units 30 will be held securely therebetween. Accordingly, the eyeglasses 10 can be placed over a shirt collar or partially within a pocket and will hold itself securely in place by virtue of the magnetic attachment of the mountable units that holds the temple pieces 20 together. The eyeglasses 10 will remain in place until the user desires to remove the eyeglasses 10 and exerts the small force necessary to free the magnets within the mountable units 30 from each other and thereby remove the grip on the article of clothing or the like to which it is attached.

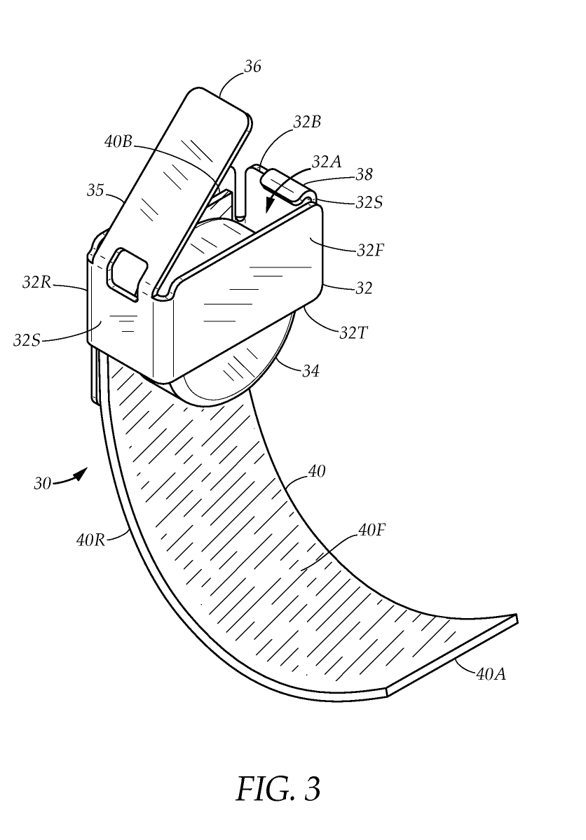

FIG. 3 illustrates an example embodiment of one of the mountable units 30. The mountable unit 30 includes a housing 32 having a front 32F, a rear 32R, a top 32T, a bottom 32B, a pair of sides 32S; and a hollow interior 32A defined by the front 32F, rear 32R, top 32T, bottom 32B, and sides 32S. The housing 32 may be made of stamped sheet metal that is folded into the generally rectangular prism shape shown, or may be made of any other suitable material, using any other suitable construction method. A magnet 34 is located within the hollow interior 32A. Note that in the example provided the magnet 34 is shown protruding from the top 32T of the housing 32 for illustrative purposes. It should be noted, however, that the magnet 34 may be provided in any suitable size and shape, including similar to the form illustrated except where the magnet does not protrude from the top 32T of the housing, and may also be provided as a rectangular shape that fits fully within the hollow interior 32A.

The mountable unit 30 also includes a securing strap 40 having a front 40F, a rear 40R, a free end 40A and a fixed end 40B. The securing strap 40 is flexible and bendable and may be made of polyester or any other suitable material. The rear 40R of the fixed end 40B is permanently attached against the rear 32R of the housing 32 within the housing interior 32A, such that it protrudes from the top 32T of the housing 32.

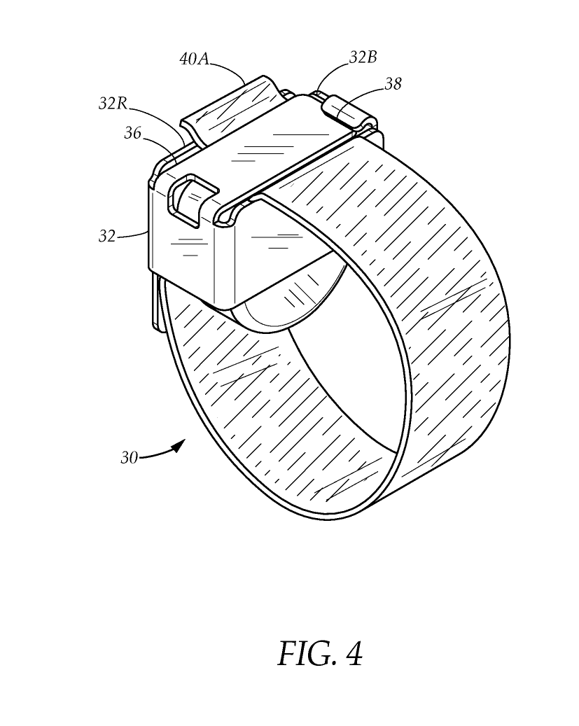

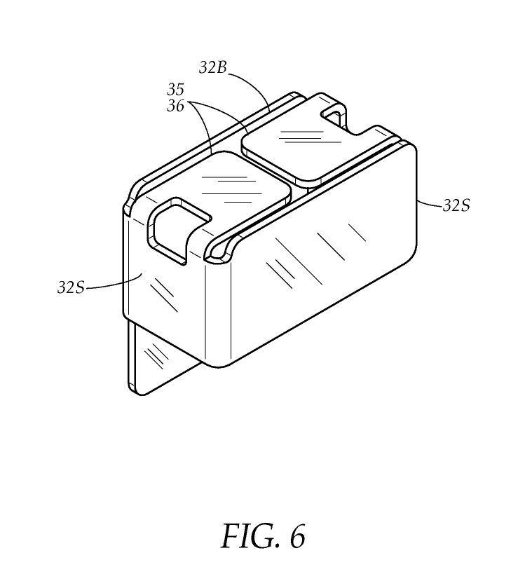

Referring to FIGS. 3 and 4, the mountable unit 30 has a clamping mechanism 35 at the bottom 32B of the housing 32. The clamping mechanism may include a selectively closable door 36 and a latch 38. The free end 40A of the securing strap 40 is employed to wrap around the eyeglasses and then is secured at the bottom 32B of the housing 32 by the clamping mechanism 35. In particular, the free end 40A of the strap is extended across the bottom 32B of the housing 32 and the door 36 is closed to clamp down onto the strap 40. The strap 40 may then be trimmed from the free end 40A up to the rear 32R of the housing. FIG. 6 illustrates a further embodiment of the clamping mechanism 35, where two closable doors 36 are provided that each extend inwardly from one of the sides 32S nearly half way across the bottom 32B. The closable doors 36 may be configured to bend so that once the strap 40 (FIGS. 3 and 4) is in place, the closable doors 36 are bent over the strap to hold it in place. Small spikes or other frictional items may be employed on the doors to bite into the strap and securely hold it in place. Numerous additional variations are possible.

Referring to FIGS. 1 and 2, the mountable units 30 are each attached onto the eyeglasses 10 by holding the top 32T of the housing 32 against the bottom 20B of one of the temple pieces 20, such that the strap extends upwardly against the outside surface 202 of the temple piece 20. The strap 40 is then extended over the top 20T of the temple piece 20, downwardly against the inside surface 201 of the temple piece, and across the bottom 32B of the housing, where the clamping mechanism 35 is closed to secure it in place. The strap 40 may optionally include double sided tape on its front 40F to increase the bond between the strap 40 and temple piece 20 and to also resist slipping along the temple piece 20 once mounted in place.

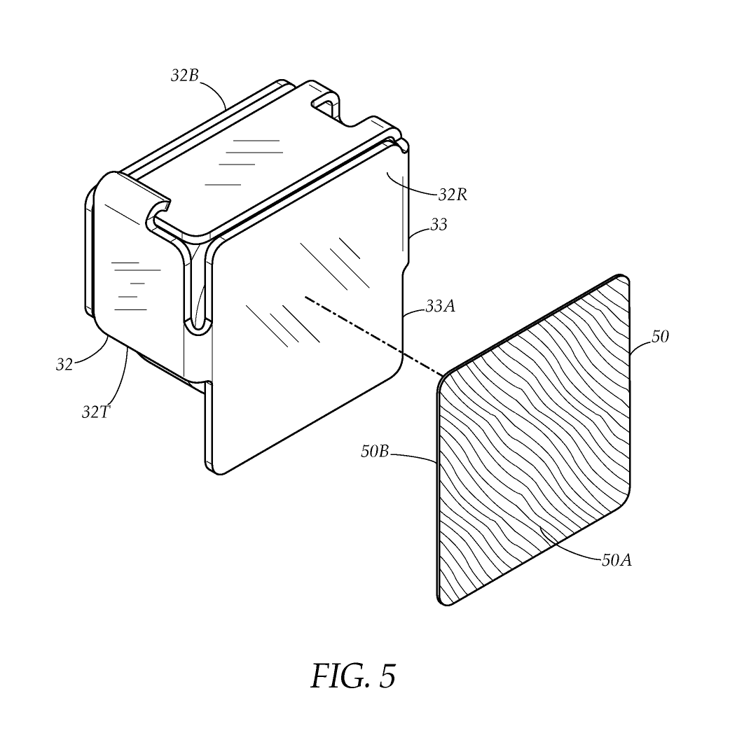

FIG. 5 illustrates the rear 32R of the housing 32, having a rear plate 33 that extends from the bottom 32B to the top 32T and has a upper portion 33A that protrudes significantly beyond the top 32T. As seen in FIG. 1, the upper portion 33A extends alongside the outside surface 201 of the temple pieces 20 and traps the strap 40 therebetween as well as providing additional surface area for the fixed end 40B to attach to the rear 32R of the housing (FIGS. 3 and 4). It should be noted, however, that the upper portion 33A may be constructed in any suitable size and shape, including in the form where the upper portion 33A does not protrude beyond the top 32T. As illustrated in FIG. 5, a decorative panel 50 may be secured to the rear plate 33 to enhance the aesthetic appearance of the mountable unit 30. In particular, the decorative panel 50 is sized to cover the rear plate 33 and may have a printed pattern 50A on one side and an adhesive material 50B on an opposite side to facilitate attachment to the rear plate 33.

It is understood that when an element is referred hereinabove as being “on” another element, it can be directly on the other element or intervening elements may be present therebetween. In contrast, when an element is referred to as being “directly on” another element, there are no intervening elements present.

Moreover, any components or materials can be formed from a same, structurally continuous piece or separately fabricated and connected.

It is further understood that, although ordinal terms, such as, “first,” “second,” “third,” are used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

Spatially relative terms, such as “beneath,” “below,” “lower,” “above,” “upper” and the like, are used herein for ease of description to describe one element or feature's relationship to another element(s) or feature(s) as illustrated in the figures. It is understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device can be otherwise oriented (rotated 90 degrees or at other orientations) and the spatially relative descriptors used herein interpreted accordingly.

Example embodiments are described herein with reference to cross section illustrations that are schematic illustrations of idealized embodiments. As such, variations from the shapes of the illustrations as a result, for example, of manufacturing techniques and/or tolerances, are to be expected. Thus, example embodiments described herein should not be construed as limited to the particular shapes of regions as illustrated herein, but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

In conclusion, herein is presented an eyeglass attachment system. The disclosure is illustrated by example in the drawing figures, and throughout the written description. It should be understood that numerous variations are possible, while adhering to the inventive concept. Such variations are contemplated as being a part of the present disclosure.

What is claimed is:

1. A magnetic eyeglass attachment system, for use with eyeglasses having a frame having a main portion and a first temple piece and a second temple piece hingedly attached to the main portion, the magnetic eyeglass attachment system comprising:
a first mountable unit and a second mountable unit, wherein each mountable unit comprises:
a housing;
a flexible securing strap having a free end and a fixed end, the fixed end being permanently attached to said housing and the free end extending from said housing;
a clamping mechanism being positioned on said housing;
a magnet being positioned in said housing;
wherein each of the mountable units is attached onto one of the temple pieces by extending the securing strap around one of the temple pieces and then securing it in place with the clamping mechanism, the first mountable unit being positioned on the first temple piece and the second mountable unit being positioned on the second temple piece, the mountable units being suitably positioned so that when the eyeglasses are in the folded position the mountable units are brought into close proximity with each other and join securely together magnetically.

2. The system of claim 1, wherein said housing is constructed of stamped sheet metal.

3. The system of claim 1, wherein said securing strap is constructed of polyester.

4. The system of claim 1, wherein said securing strap is constructed of nylon.

5. The system of claim 1, wherein said securing strap is constructed of silicone.

6. The system of claim 1, wherein the shape of said magnet is rectangular.

7. The system of claim 1, wherein said clamping mechanism is comprised of a selectively closable door and a latch.

8. The system of claim 1, wherein said clamping mechanism is comprised of one or more selectively closable doors.

9. The system of claim 8, wherein said selectively closable doors further comprise spikes employed to hold said securing strap substantially in place.

10. The system of claim 8, wherein said selectively closable doors further comprise frictional items employed to hold said securing strap substantially in place.
